(19) United States
(12) Patent Application Publication
(10) Pub. No.: US 2006/0041893 A1
(43) Pub. Date: Feb. 23, 2006

(54) Extensible device synchronization architecture and user interface

(75) Inventors: Alexander Castro, Issaquah, WA (US); Giles van der Bogert, Kirkland, WA (US); Oliver Lee, Redmond, WA (US); Kelly Rollin, Seattle, WA (US); Christopher Araman, Seattle, WA (US); Marieke Iwema Watson, Seattle, WA (US); Andrew Silverman, Redmond, WA (US); Brian D. Wentz, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 10/923,609

(22) Filed: Aug. 20, 2004

(51) Int. Cl. G06F 9/44

(52) U.S. Cl. 719/320; 719/328

(57) ABSTRACT

An extensible device synchronization architecture and user interface is provided. A variety of device classes are supported, and support is also provided for mass storage, WMDM, MTP, AS, etc. An extensible UI model is provided that allows content type specific setting UI to plug-in. Support for 2-way synchronization is also provided. The synchronization architecture includes a content type user experience level, and a synchronization engine layer, with handlers and a synchronization engine API which handlers can use to manage their item level synchronization relationships and implement the semantics of the synchronization. In addition, the content that is being synchronized may be transformed so that the user's experience on the destination device (e.g., mobile phone, portable audio player, PDA, other type of personal or handheld computer, etc.) is optimized and these transforms are also extensible.

### FIELD OF THE INVENTION

The embodiment of the present invention relates to synchronization, and more particularly, to device synchronization across a wide array of content types and device classes.

### BACKGROUND OF THE INVENTION

Many computer users own (or have regular access to) multiple devices which store data and files. For example, a user may own or have regular access to a desktop computer, a PDA, a mobile phone, a portable audio player, etc. One of the difficulties associated with maintaining different devices is keeping data and files current between the different devices. For example, if the user updates or creates a new file on one device, and later wishes to update that file on another device, a copy of the file from the first device must be transferred to the second device in order to ensure that the most recent version of the file is available on the second device. Once the user has modified or created a new file on the second device, in order to later use the file on the first device, a copy of the file must be transferred back to the first device. Failing to make this transfer may result in changes being lost. As another example, a user may also have data that is contained in a store (e.g. a contact) that needs to be synchronized between two stores on two different devices (e.g. a contact as an item within a store on a PC that is to be synchronized with a device such as a mobile phone.)

Several known systems have been directed to synchronization and transfer of data to devices from a PC, however, none of these provide an integrated user experience and extensible architecture. In summary, the known approaches to synchronization do not provide extensible support for any content type, and they do not provide extensible support for a variety of device classes.

The embodiment of the present invention is directed to overcoming the foregoing and other disadvantages. More specifically, the present invention is directed to an extensible system that enables device synchronization across a wide array of content types and device classes, including other types of computers.

### SUMMARY OF THE INVENTION

In accordance with one aspect of the invention, a simple and extensible way to enable device synchronization across a wide array of content types and device classes is provided. A variety of device classes are supported, and support is also provided for mass storage, WMDM, MTP, AS, etc. An extensible UI model is provided that allows content type specific setting UI to plug-in. In other words, a unified UI framework is provided that is extensible for setting up and changing synchronization with portable devices. Support for 2-way synchronization is also provided. The synchronization architecture includes a content type user experience level, and a synchronization engine layer, with handlers and a synchronization engine API which handlers can use to manage their item level synchronization relationships and implement the semantics of the synchronization.

In accordance with another aspect of the invention, user experience and synchronization engine layers are provided, each of which are extensible. At the user experience level, there is a high level content of “content types” (for example, music, photos, contacts, documents, etc.). A high level page is provided which lists all of the content types which are configurable. Applications can register to handle particular content types. Registering for a particular content type allows the applications to provide a user interface for drilling down and configuring that particular type of content. Handlers are responsible for storing custom selections/settings made by the user. This provides extensibility at the user interface layer. At the synchronization engine layer, the handlers are also invoked when a synchronization is started. Each handler is responsible for synchronizing content based on the user settings and reporting progress, conflicts, etc., back to the shell management layer. Furthermore, the shell also provides a synchronization engine API which handlers can use to manage their item level synchronization relationships and implement the semantics of the synchronization.

In accordance with another aspect of the invention, as part of the synchronization process, content may be transformed so that the user's experience on the destination device (e.g., mobile phone, portable audio player, PDA, etc.) is optimized. In other words, device synchronization via a device's operating system allows users to use the device to roam with their data. Available devices possess a wide range of characteristics (e.g., storage size available compared to storage on a PC, ability to consume the data on the device itself, ability to modify the data using a device, etc.). With transformation as part of the device synchronization process, data from a PC can be optimized for the device. An extensible framework is included that allows for transformations for specific types of content to be plugged in, or for the specific transformations for specific content to be plugged in. Information can be utilized about a device's capability supplied by the device, by the user, or a combination to determine what transformations should be applied for a data-type as part of the synchronization process.

In accordance with another aspect of the invention, information about a device's capabilities is utilized to determine what handlers (contacts, music, etc) are displayed in the sync setup dialog. For example, if a phone is attached then certain capabilities may be designated as having a higher priority (e.g. contacts may appear higher in the list than music.) Also, the specific device's capabilities may specify what type of default option to select (e.g. all contacts, personal contacts, etc) so that the user doesn't have to make a selection and can choose the default option that has been optimized for the devices capabilities (e.g. function, storage space, etc.).

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a general purpose computer system suitable for implementing the embodiment of the present invention;

FIGS. 2A-2L are block diagrams illustrating various implementations of a programming interface that may be utilized for implementing the embodiment of the present invention;

FIG. 3 is a flow diagram illustrative of a general routine for a synchronization system;

FIG. 4 is a flow diagram illustrative of a routine for synchronizing a device to a computer;

FIG. 5 is a diagram illustrative of a screen display in which a device is connected and ready for use;

FIG. 6 is a diagram illustrative of a screen display in which a connection with a server has been detected and the user is provided with options for synchronization;

FIG. 7 is a diagram illustrative of a screen display in which a user is provided with options regarding the timing of the synchronization;

FIG. 8 is a diagram illustrative of a screen display in which a user is provided with options for what to synchronize to the device;

FIG. 9 is a diagram illustrative of a screen display in which a user is provided with options for synchronization with a computer or a server;

FIG. 10 is a diagram illustrative of a screen display in which a user is provided with options for synchronizing a music library;

FIG. 11 is a diagram illustrative of a screen display in which a user is provided with options for what specific content to synchronize from the music library;

FIG. 12 is a diagram illustrative of a screen display in which a user is provided with options for saving the user's settings and synchronizing the device;

FIG. 13 is a diagram illustrative of a screen display in which the synchronization has started and is progressing;

FIG. 14 is a diagram illustrative of a screen display in which the synchronization has been completed;

FIG. 15 is a block diagram illustrating the components of a synchronization system in which content may be transformed as part of the synchronization process;

FIG. 16 is a flow diagram illustrative of a general routine for synchronizing general content to a device;

FIG. 17 is a flow diagram illustrative of a routine with specific procedures for synchronizing image content;

FIG. 18 is a flow diagram illustrative of a routine with specific procedures for synchronizing audio content;

FIG. 19 is a flow diagram illustrative of a routine with specific procedures for synchronizing video content;

FIG. 20 is a flow diagram illustrative of a routine with specific procedures for synchronizing document content; and

FIG. 21 is a flow diagram illustrative of a routine with specific procedures for synchronizing contact content.

### DETAILED DESCRIPTION OF THE PREFERRED EMBODIMENT

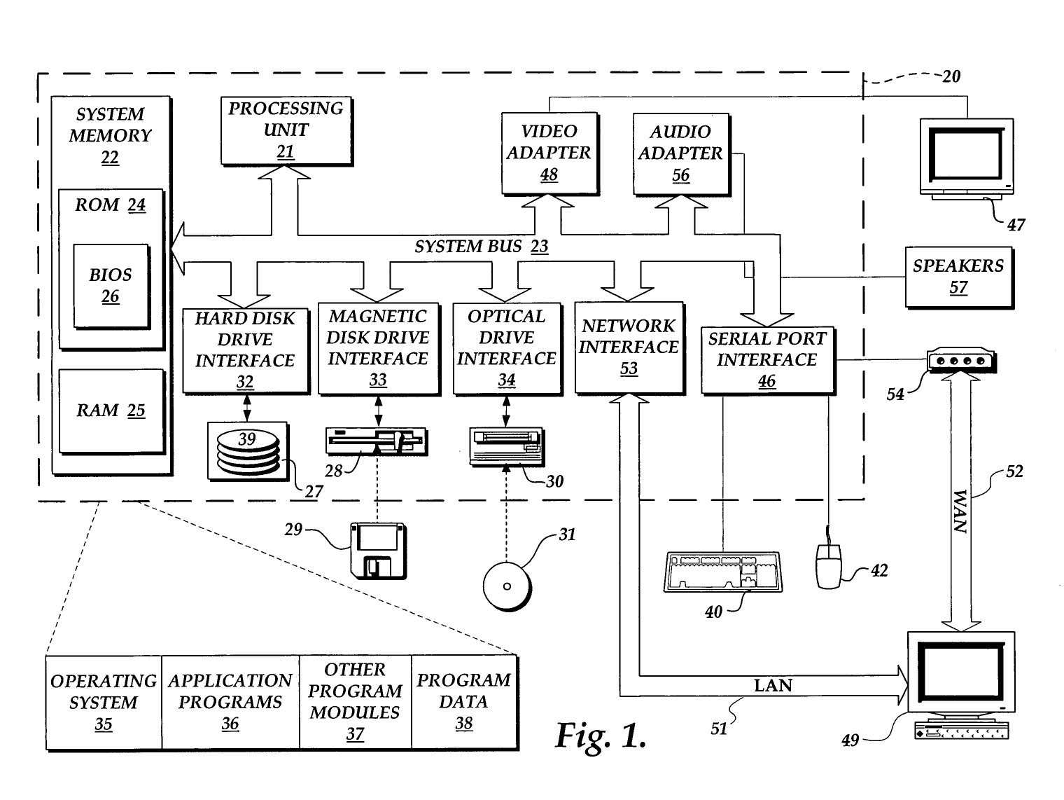

FIG. 1 and the following discussion are intended to provide a brief, general description of a suitable computing environment in which the embodiment of the present invention may be implemented. Although not required, the invention will be described in the general context of computer-executable instructions, such as program modules, being executed by a personal computer. Generally, program modules include routines, programs, characters, components, data structures, etc., that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 1, an exemplary system for implementing the invention includes a general purpose computing device in the form of a conventional personal computer 20, including a processing unit 21, system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that helps to transfer information between elements within the personal computer 20, such as during start-up, is stored in ROM 24. The personal computer 20 further includes a hard disk drive 27 for reading from or writing to a hard disk 39, a magnetic disk drive 28 for reading from or writing to a removable magnetic disk 29, and an optical disk drive 30 for reading from or writing to a removable optical disk 31, such as a CD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer-readable instructions, data structures, program modules, and other data for the personal computer 20. Although the exemplary environment described herein employs a hard disk 39, a removable magnetic disk 29, and a removable optical disk 31, it should be appreciated by those skilled in the art that other types of computer-readable media which can store data that is accessible by a computer, such as magnetic cassettes, flash memory cards, digital video disks, Bernoulli cartridges, random access memories (RAMs), read-only memories (ROMs), and the like, may also be used in the exemplary operating environment.

A number of program modules may be stored on the hard disk 39, magnetic disk 29, optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus 23, but may also be connected by other interfaces, such as a parallel port, game port or a universal serial bus (USB). A display in the form of a monitor 47 is also connected to the system bus 23 via an interface, such as a video card or adapter 48. One or more speakers 57 may also be connected to the system bus 23 via an interface, such as an audio adapter 56. In addition to the display and speakers, personal computers typically include other peripheral output devices (not shown), such as printers.

The personal computer 20 may operate in a networked environment using logical connections to one or more personal computers, such as a remote computer 49. The remote computer 49 may be another personal computer, a server, a router, a network PC, a peer device or other common network node, and typically includes many or all of the elements described above relative to the personal computer 20. The logical connections depicted in FIG. 1 include a local area network (LAN) 51 and a wide area network (WAN) 52. The local area network 51 and wide area network 52 may be wired, wireless, or a combination thereof. Such networking environments are commonplace in offices, enterprise-wide computer networks, intranets, and the Internet.

When used in a LAN networking environment, the personal computer 20 is connected to the local area network 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20 or portions thereof may be stored in the remote memory storage device. It will be appreciated that the network connections shown are exemplary, and other means of establishing a communications link between the computers may be used.

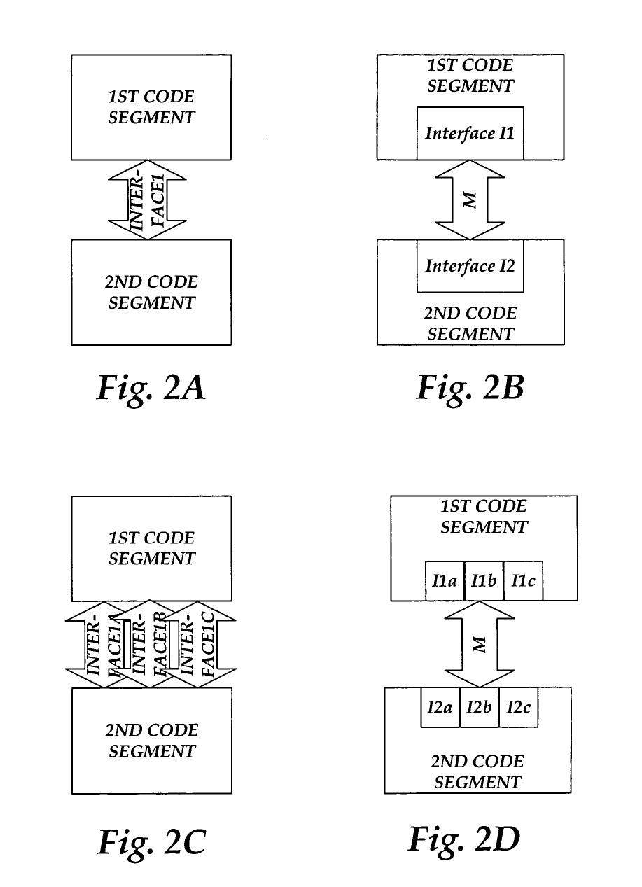

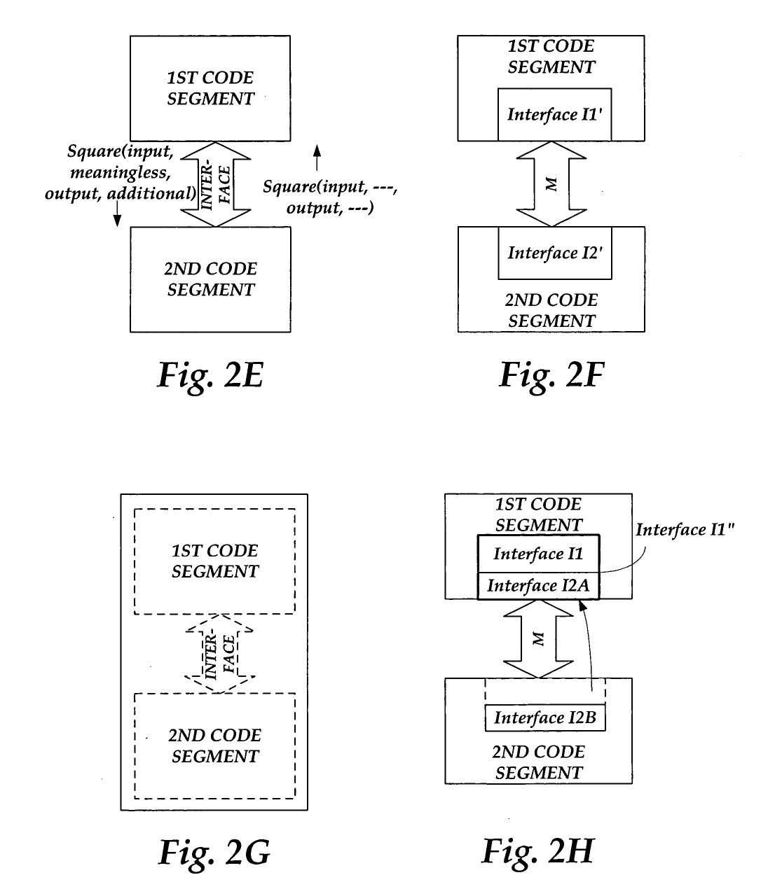

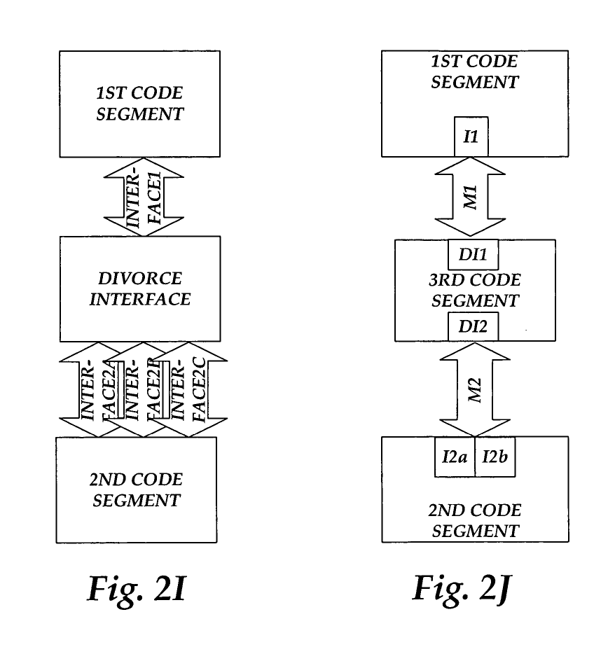

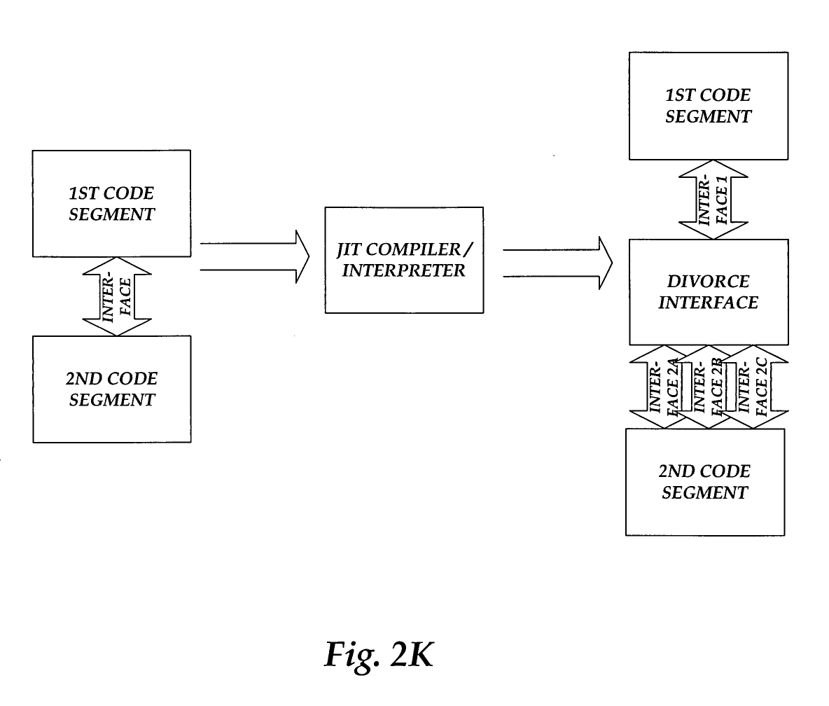

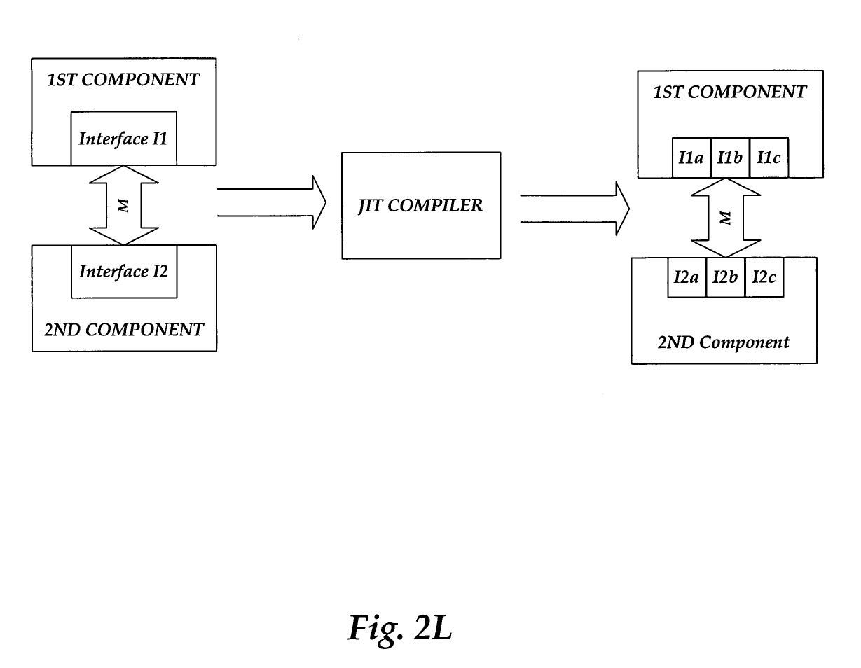

The embodiment of the present invention may utilize various programming interfaces. As will be described in more detail below with respect to FIGS. 2A-2L, a programming interface (or more simply, interface) such as that used in the system may be viewed as any mechanism, process, protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

Notionally, a programming interface may be viewed generically, as shown in FIG. 2A or FIG. 2B. FIG. 2A illustrates an interface Interface 1 as a conduit through which first and second code segments communicate. FIG. 2B illustrates an interface as comprising interface objects I1 and I2 (which may or may not be part of the first and second code segments), which enable first and second code segments of a system to communicate via medium M. In the view of FIG. 2B, one may consider interface objects I1 and I2 as separate interfaces of the same system and one may also consider that objects I1 and I2 plus medium M comprise the interface. Although FIGS. 2A and 2B show bidirectional flow and interfaces on each side of the flow, certain implementations may only have information flow in one direction (or no information flow as described below) or may only have an interface object on one side. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g., information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this list should be considered illustrative and non-limiting.

This notion of a programming interface is known to those skilled in the art and is clear from the foregoing description. There are, however, other ways to implement a programming interface, and, unless expressly excluded, these too are intended to be encompassed by the claims set forth at the end of this specification. Such other ways may appear to be more sophisticated or complex than the simplistic view of FIGS. 2A and 2B, but they nonetheless perform a similar function to accomplish the same overall result. We will now briefly describe some illustrative alternative implementations of a programming interface.

FIGS. 2C and 2D illustrate a factoring implementation. In accordance with a factoring implementation, a communication from one code segment to another may be accomplished indirectly by breaking the communication into multiple discrete communications. This is depicted schematically in FIGS. 2C and 2D. As shown, some interfaces can be described in terms of divisible sets of functionality. Thus, the interface functionality of FIGS. 2A and 2B may be factored to achieve the same result, just as one may mathematically provide 24, or 2 times 2 time 3 times 2. Accordingly, as illustrated in FIG. 2C, the function provided by interface Interface 1 may be subdivided to convert the communications of the interface into multiple interfaces. Interface 1A, Interface 1B, Interface 1C, etc. while achieving the same result. As illustrated in FIG. 2D, the function provided by interface I1 may be subdivided into multiple interfaces I1a, I1b, I1c, etc. while achieving the same result. Similarly, interface I2 of the second code segment which receives information from the first code segment may be factored into multiple interfaces I2a, I2b, I2c, etc. When factoring, the number of interfaces included with the 1st code segment need not match the number of interfaces included with the 2nd code segment. In either of the cases of FIGS. 2C and 2D, the functional spirit of interfaces Interface 1 and I1 remain the same as with FIGS. 2A and 2B, respectively. The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

FIGS. 2E and 2F illustrate a redefinition implementation. In accordance with a redefinition implementation, in some cases, it may be possible to ignore, add or redefine certain aspects (e.g., parameters) of a programming interface while still accomplishing the intended result. This is illustrated in FIGS. 2E and 2F. For example, assume interface Interface 1 of FIG. 2A includes a function call Square (input, precision, output), a call that includes three parameters, input, precision and output, and which is issued from the 1st Code Segment to the 2nd Code Segment. If the middle parameter precision is of no concern in a given scenario, as shown in FIG. 2E, it could just as well be ignored or even replaced with a meaningless (in this situation) parameter. One may also add an additional parameter of no concern. In either event, the functionality of square can be achieved, so long as output is returned after input is squared by the second code segment. Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 2F, interface I1 is replaced by interface I1′, redefined to ignore or add parameters to the interface. Interface I2 may similarly be redefined as interface I2′, redefined to ignore unnecessary parameters, or parameters that may be processed elsewhere. The point here is that in some cases a programming interface may include aspects, such as parameters, that are not needed for some purpose, and so they may be ignored or redefined, or processed elsewhere for other purposes.

FIGS. 2G and 2H illustrate an inline coding implementation. In accordance with an inline coding implementation, it may also be feasible to merge some or all of the functionality of two separate code modules such that the “interface” between them changes form. For example, the functionality of FIGS. 2A and 2B may be converted to the functionality of FIGS. 2G and 2H, respectively. In FIG. 2G, the previous 1st and 2nd Code Segments of FIG. 2A are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface Interface 1 may still be in effect. Similarly, shown in FIG. 2H, part (or all) of interface I2 from FIG. 2B may be written inline into interface I1 to form interface I1″. As illustrated, interface I2 is divided into I2a and I2b, and interface portion I2a has been coded in-line with interface I1 to form interface I1″. For a concrete example, consider that the interface I1 from FIG. 2B performs a function call square (input, output), which is received by interface I2, which after processing the value passed with input (to square it) by the second code segment, passes back the squared result with output. In such a case, the processing performed by the second code segment (squaring input) can be performed by the first code segment without a call to the interface.

FIGS. 2I and 2J illustrate a divorce implementation. In accordance with a divorce implementation, a communication from one code segment to another may be accomplished indirectly by breaking the communication into multiple discrete communications. This is depicted schematically in FIGS. 2I and 2J. As shown in FIG. 2I, one or more piece(s) of middleware (Divorce Interface(s), since they divorce functionality and/or interface functions from the original interface) are provided to convert the communications on the first interface, Interface 1, to conform them to a different interface, in this case interfaces Interface 2A, Interface 2B and Interface 2C. This might be done, e.g., where there is an installed base of applications designed to communicate with, say, an operating system in accordance with an Interface 1 protocol, but then the operating system is changed to use a different interface, in this case interfaces Interface 2A, Interface 2B and Interface 2C. The point is that the original interface used by the 2nd Code Segment is changed such that it is no longer compatible with the interface used by the 1^{st} Code Segment, and so an intermediary is used to make the old and new interfaces compatible. Similarly, as shown in FIG. 2J, a third code segment can be introduced with divorce interface DI1 to receive the communications from interface I1 and with divorce interface DI2 to transmit the interface functionality to, for example, interfaces I2a and I2b, redesigned to work with DI2, but to provide the same functional result. Similarly, DI1 and DI2 may work together to translate the functionality of interfaces I1 and I2 of FIG. 2B to a new operating system, while providing the same or similar functional result.

FIGS. 2K and 2L illustrate a rewriting implementation. In accordance with a rewriting implementation, yet another possible variant is to dynamically rewrite the code to replace the interface functionality with something else but which achieves the same overall result. For example, there may be a system in which a code segment presented in an intermediate language (e.g., Microsoft Ill., Java ByteCode, etc.) is provided to a Just-in-Time (JIT) compiler or interpreter in an execution environment (such as that provided by the Net framework, the Java runtime environment, or other similar runtime type environments). The JIT compiler may be written so as to dynamically convert the communications from the 1st Code Segment to the 2nd Code Segment, i.e., to conform them to a different interface as may be required by the 2nd Code Segment (either the original or a different 2nd Code Segment). This is depicted in FIGS. 2K and 2L. As can be seen in FIG. 2K, this approach is similar to the divorce configuration described above. It might be done, e.g., where an installed base of applications are designed to communicate with an operating system in accordance with an Interface 1 protocol, but then the operating system is changed to use a different interface. The JIT Compiler could be used to conform the communications on the fly from the installed-base applications to the new interface of the operating system. As depicted in FIG. 2L, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched and combined to produce the same or equivalent scenarios to the generic scenarios presented in FIGS. 2A and 2B. It is also noted that, as with most programming constructs, there are other similar ways of achieving the same or similar functionality of an interface which may not be described herein, but nonetheless are represented by the spirit and scope of the invention, i.e., it is noted that it is at least partly the functionality represented by, and the advantageous results enabled by, an interface that underlie the value of an interface.

As will be described in more detail below, known approaches to synchronization do not provide extensible support for a variety of content types or for a variety of device classes. The embodiment of the present invention provides simple, and extensible, ways to enable device synchronization across a wide array of content types and device classes. Support is provided for a variety of device classes and content types, as well as mass storage, and two-way synchronization. An extensible UI model is also provided that allows content type specific setting UI to plug-in. The synchronization architecture includes a “content type” experience user level and a synchronization engine layer with handlers and a synchronization engine API which handlers can use to manage their item level synchronization relationships and implement the semantics of the synchronization.

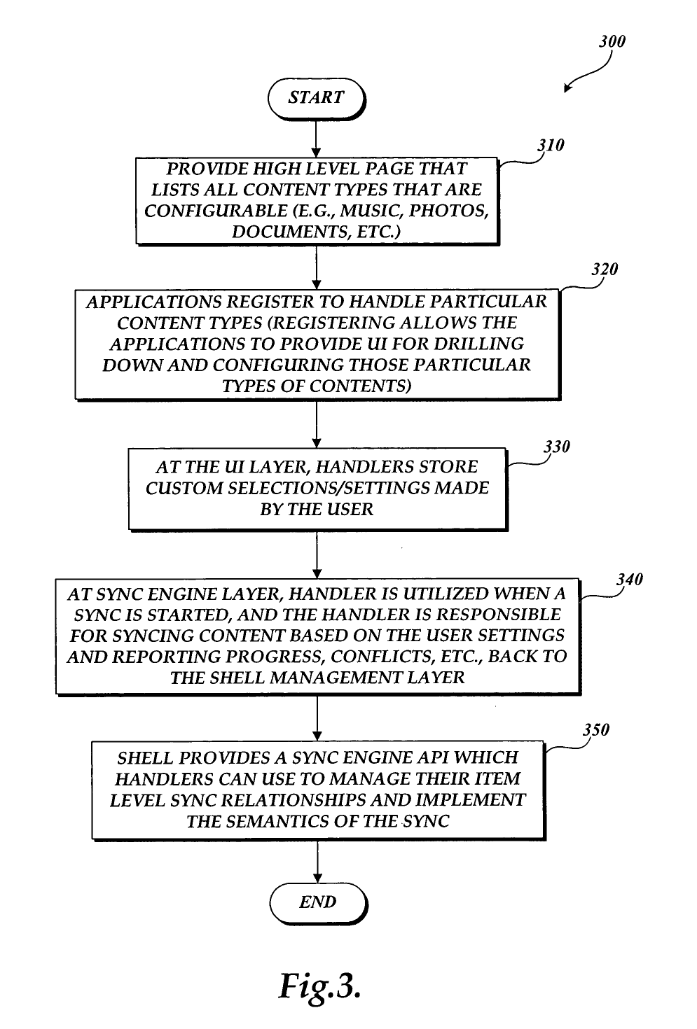

FIG. 3 is a flow diagram illustrative of a general routine 300 for a synchronization system. At a block 310, a high level page is provided which lists all of the content types (e.g., music, photos, documents, etc.) that are configurable. At a block 320, applications register to handle particular content types. By registering for a particular content type, the applications are able to provide UI for drilling down and configuring that particular type of content. At a block 330, handlers store the custom selections/settings made by the user. This is the extensibility at the UI layer. At a block 340, at the synchronization engine layer, the handlers are also invoked when a synchronization is started. The handlers are responsible for synchronizing content based on the user settings and reporting the progress, conflicts, etc., back to the shell management layer. At a block 350, the shell also provides a synchronization engine API which handlers can use to manage their item level synchronization relationships and to implement the semantics of the synchronization.

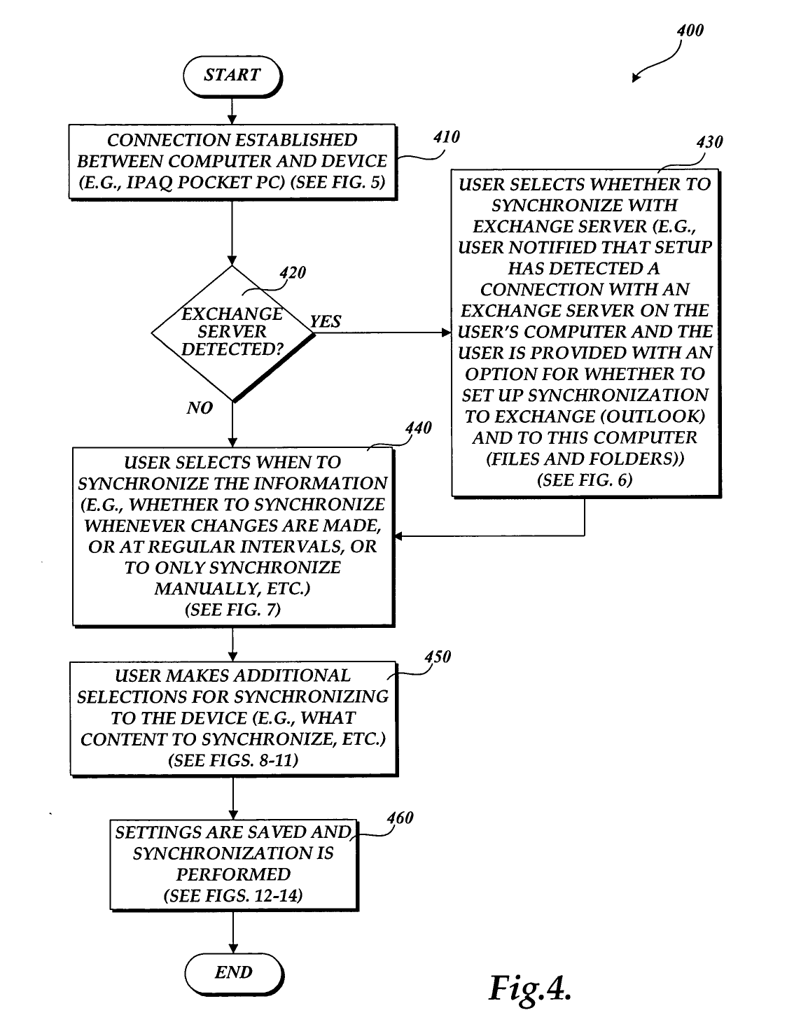

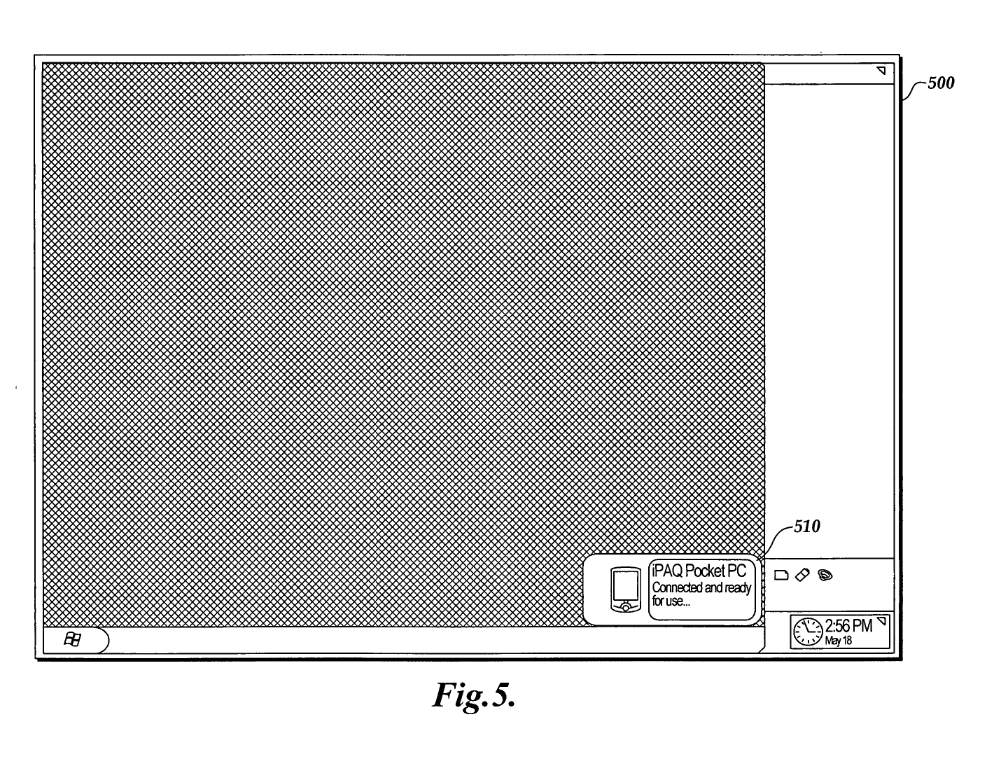

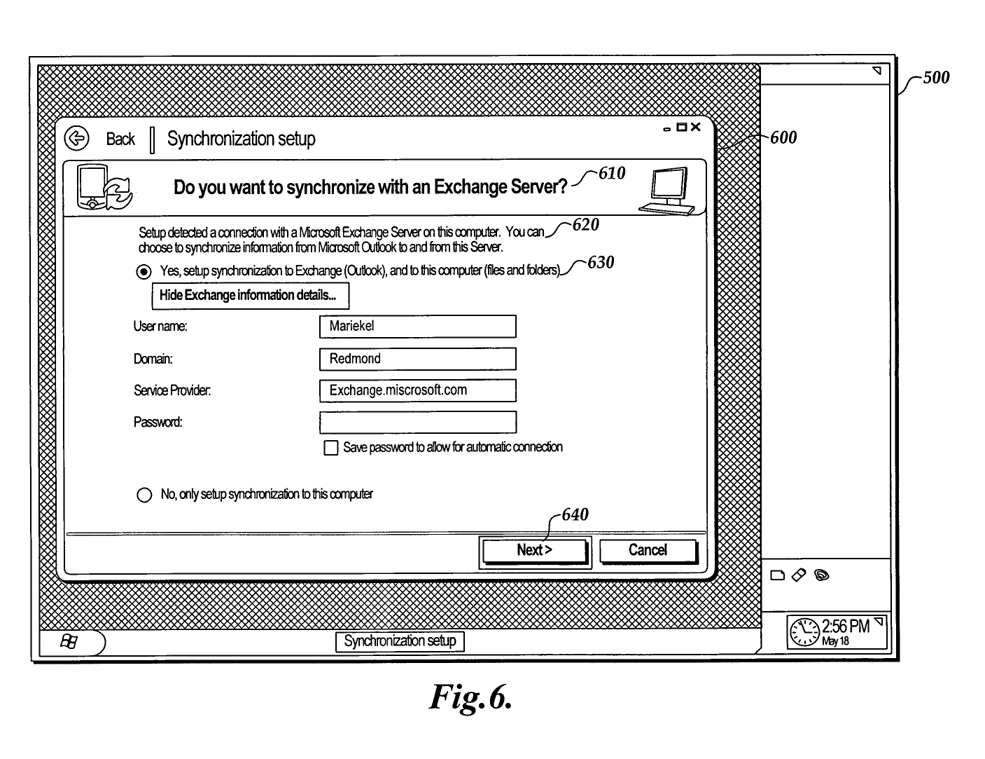

FIG. 4 is a flow diagram illustrative of a routine 400 for synchronizing a device to a computer. At a block 410, a connection is established between a computer and a device (e.g., an iPAQ Pocket PC), as will be illustrated below with reference to FIG. 5. At a decision block 420, a determination is made as to whether a server (e.g., an Exchange Server) is detected. If a server is not detected, then the routine continues to a block 440, as will be described in more detail below. If a server is detected, then the routine continues to a block 430, where the user is provided with an indication that the server has been detected, and an option for setting up the synchronization to the server (e.g., Outlook) and to the user's computer (e.g., files and folders), as will be illustrated below with reference to FIG. 6.

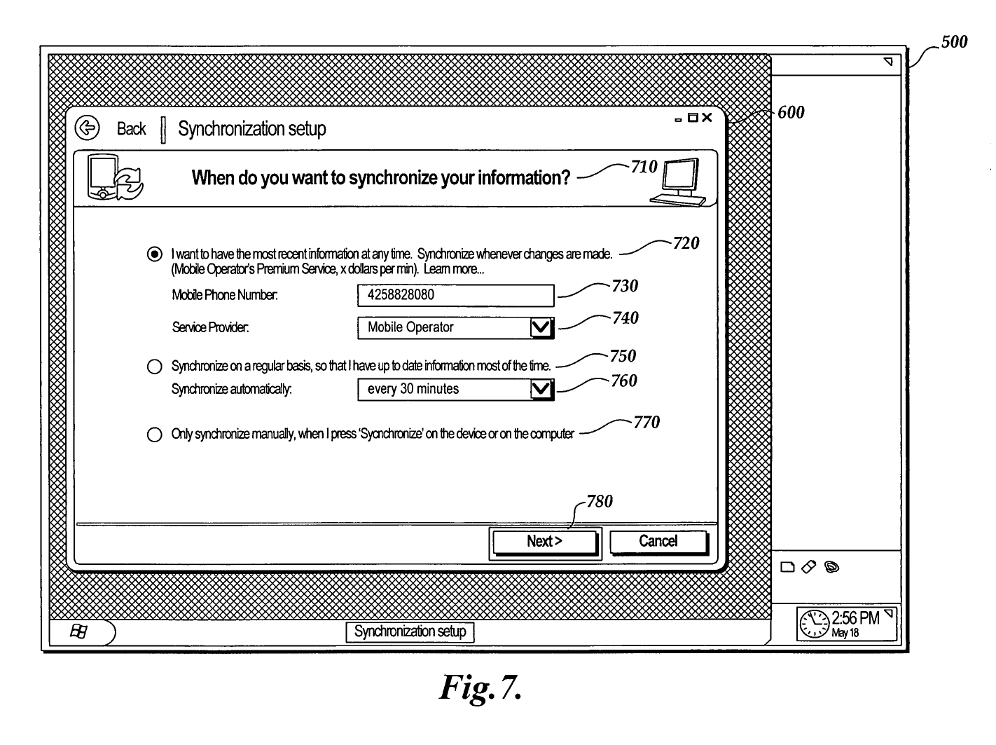

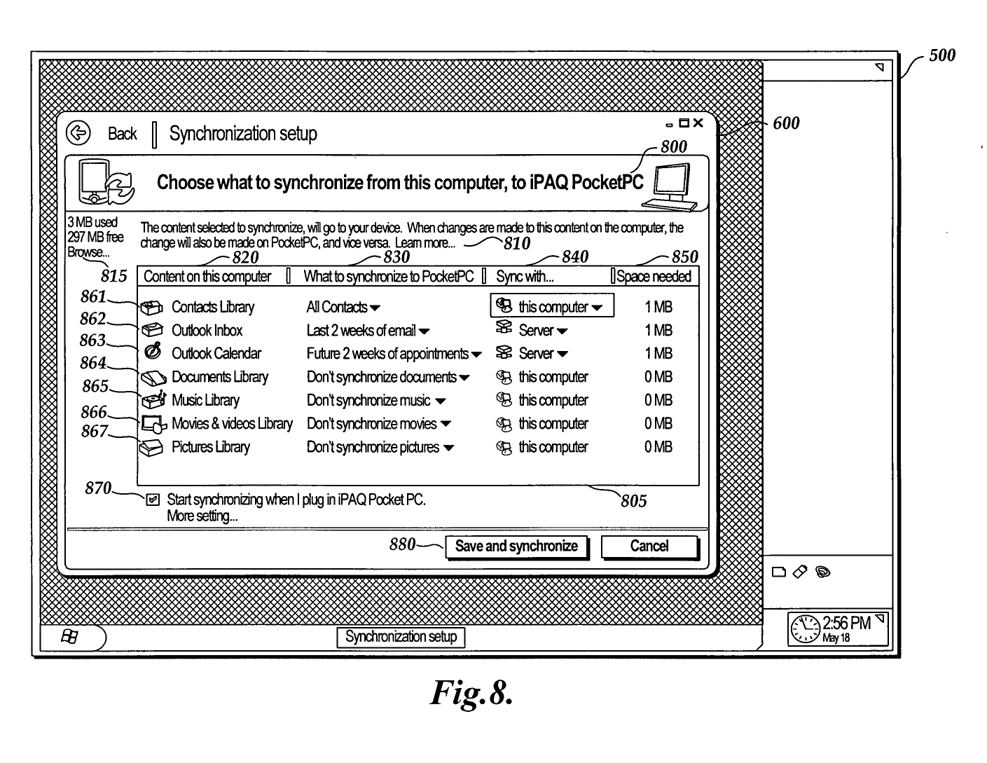

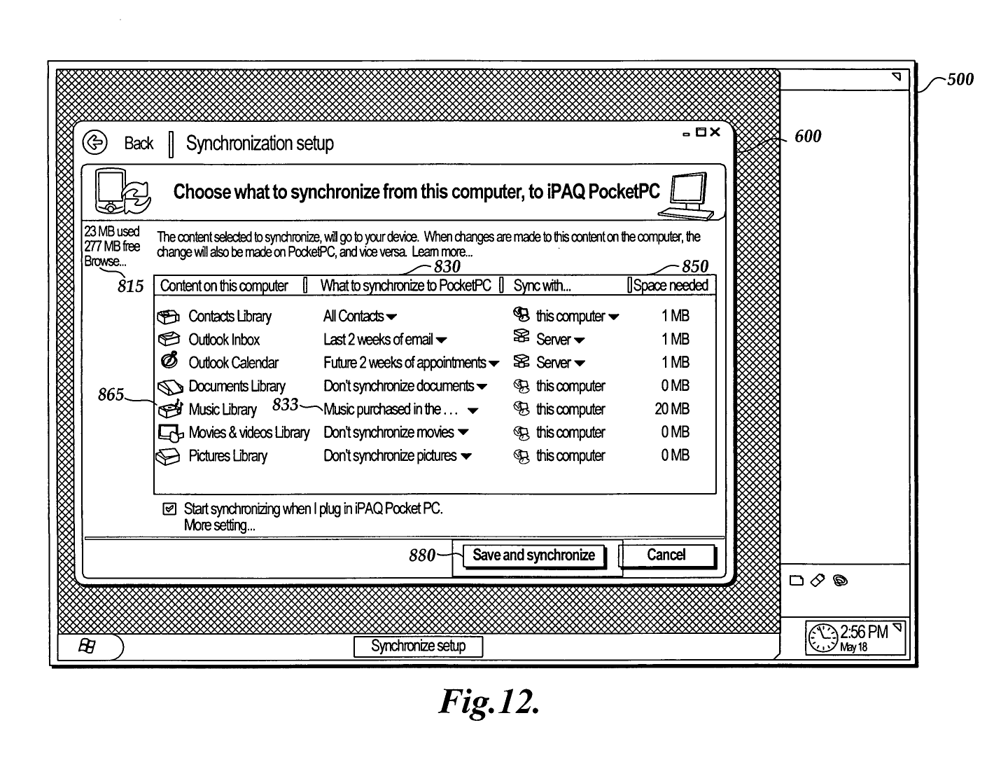

At a block 440, a user selects the timing for when the information is to be synchronized (e.g. whether to synchronize whenever changes are made, or at regular intervals, or to only synchronize manually, etc.), as will be illustrated below with reference to FIG. 7. At a block 450, the user makes additional selections for synchronizing to the device (e.g., what content to synchronize, etc.), as will be illustrated below with reference to FIGS. 8-11. At a block 460, the settings are saved and the synchronization is performed, as will be illustrated below with reference to FIGS. 12-14.

FIG. 5 is a diagram illustrative of a screen display 500 in which a connection is established between a computer and a device. As shown in FIG. 5, in a display area 510 an indication is provided that “iPAQ Pocket PC connected and ready for use”. As will be described in more detail below, once a device is connected and ready for use, options may be provided to the user for the synchronization process.

FIG. 6 is a diagram illustrative of a screen display in which a connection with a server has been detected and the user is provided with options for synchronization. As shown in FIG. 6, the screen display 500 is shown to include a window 600 which in a display area 610 has a title of “do you want to synchronize with an Exchange Server?” In a display area 620, the user is informed “setup detected a connection with a Microsoft Exchange Server on this computer. You can choose to synchronize information from Microsoft Outlook to and from this Server.” In a display area 630, the user is provided with a selection area for “Yes, set up synchronization to Exchange (Outlook), and to this computer (files and folders).” Once the user has selected synchronization to occur, the user selects a “Next” button 640, which continues the process, as will be described in more detail below with reference to FIG. 7.

FIG. 7 is a diagram illustrative of a screen display in which a user is provided with options regarding the timing for when the synchronization is to occur. As shown in FIG. 7, in a display area 710, a window is provided with a title of “when do you want to synchronize your information?” In a display area 720, the user is provided with a selection area titled “I want to have the most recent information at any time. Synchronize whenever changes are made”. In a display area 730, the user may make an entry for a “Mobile Phone Number” for the synchronization, and in a display area 740 the user may select a “Service Provider”. In a display area 750, the user is provided with a selection area titled “synchronize on a regular basis, so that I have up to date information most of the time” (in one embodiment, the information being synchronized may be dynamic in that the content may change automatically over time without the user having to change settings.) In a display area 760, the user is able to select a time period for determining how often the system is to “synchronize automatically” (e.g. every 30 minutes). In a display area 770, the user is provided with a selection area titled “only synchronize manually, when I press ‘synchronize’ on the device or on the computer”. Once a selection has been made, the user selects a “Next” button 780, which continues the process, as will be described in more detail below with reference to FIG. 8.

FIG. 8 is a diagram illustrative of the screen display in which a user is presented with options for choosing what to synchronize from the user's computer to the device. In a display area 800, the window is provided with a title of “choose what to synchronize from this computer to iPAQ Pocket PC”. In a display area 810, the user is informed that “the content selected to synchronize will go to your device. When changes are made to this content on the computer, the change will also be made on Pocket PC, and vice versa”. In a display area 815, an indication is provided of the amount of memory that is currently used and the amount of memory that is currently free (i.e., “3 MB used, 297 MB free”). In a display area 805, a user is provided with selections for what content to synchronize. A display column 820 shows the “content on this computer”, a display column 830 shows “what to synchronize to Pocket PC”, a display column 840 shows what the device is to be “sync with”, and a display column 850 shows the “space needed” for synchronizing the selected content. A display row 861 shows a “contacts library”, a display row 862 shows an “outlook inbox”, a display row 863 shows an “outlook calendar”, a display row 864 shows a “documents library”, a display row 865 shows a “music library”, a display row 866 shows a “movies and videos library”, and a display row 867 shows a “pictures library”. In one embodiment, the display rows only display content types that can be handled by the device. The list may also differ based on the programs installed on the PC. As examples of selections in the display column 830 for the “what to synchronize to Pocket PC”, for the “contacts library” a current selection is “all contacts”, while for the “outlook inbox” a current selection is for “last 2 weeks of email”, and for the “outlook calendar”, a current selection is for “future 2 weeks of appointments”. As examples of selections in the display column 840 for indicating “what to synchronize to Pocket PC” for the “contacts library” a current selection is for “this computer”, while for the “outlook inbox” a current selection is for the “server”. In the display column 850, which indicates the “space needed”, indications are provided of the various amounts of the storage capacity that is needed on the Pocket PC for the synchronization to be performed. At a display area 870, the user is provided with a check-box to “start synchronizing when I plug in iPAQ Pocket PC”. In one embodiment, clicking on the link may also display additional settings such as to when to synchronize (e.g. on plug-in, always, manually, at 5 pm at night, etc.), how to resolve conflicts (e.g. device wins, PC wins, newest file wins, etc.), encoding settings, etc. A button 880 is provided for the user to “save and synchronize”. In one embodiment, the UI described above and below is used primarily for the setup of the sync, after which the next time the user plugs in the device, the settings are known, and the sync just occurs in the background.

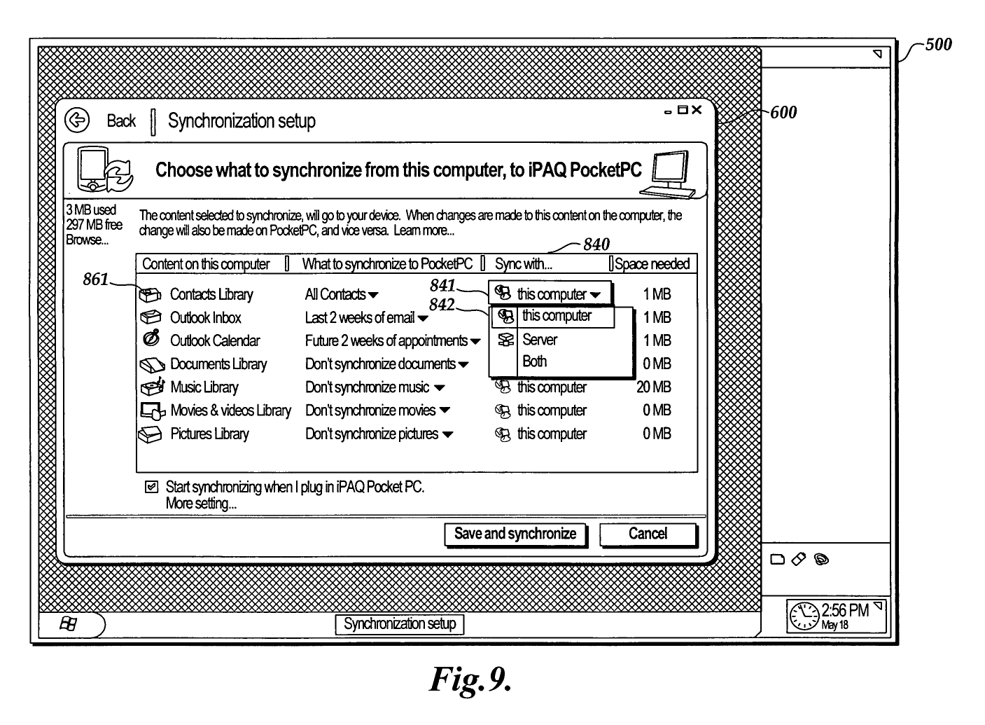

FIG. 9 is a diagram illustrative of a screen display in which a user makes a selection for what the Pocket PC is to be synchronized with. As shown in FIG. 9, for the display row 861 for the “contacts library”, the user has made a selection within the display column 840 for “sync with”. Once the display area 841 is selected, a drop-down menu 842 is provided which indicates that the user may select “this computer”, “server”, or “both”. Through this process, the user may select what the Pocket PC is to be synchronized with.

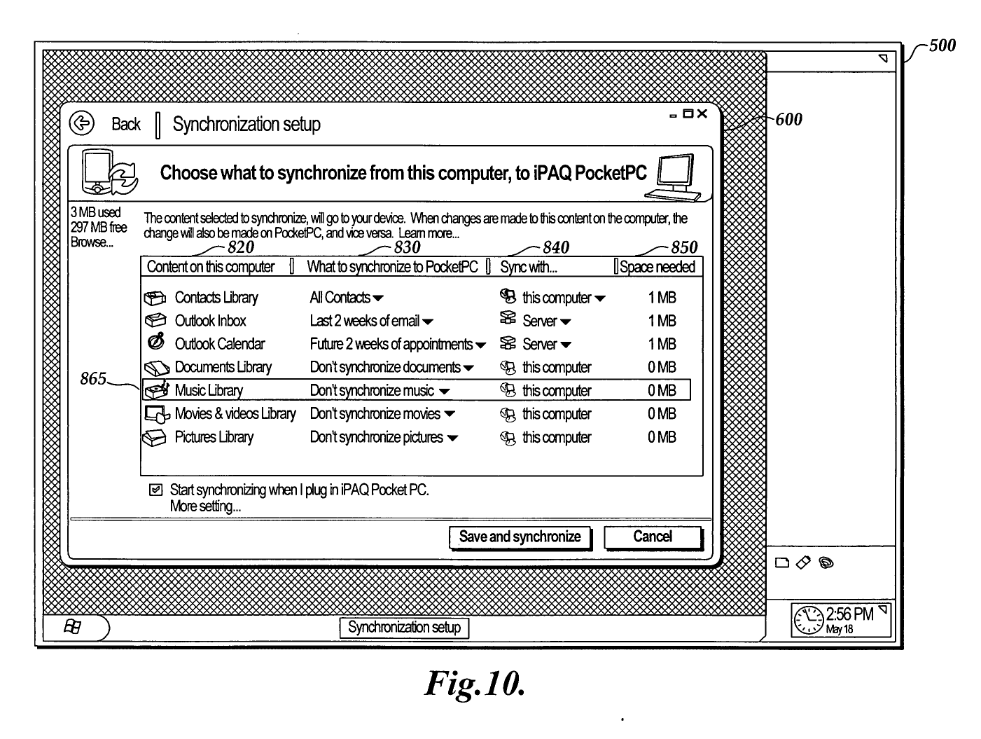

FIG. 10 is a diagram illustrative of a screen display in which the user has selected the display row for the “music library”. For the display row 865 for the “music library”, in the display column 830 for the “what to synchronize to Pocket PC”, the current setting is for “don't synchronize music”. For the display column 840 for “sync with”, the current setting is for “this computer”. For the display column 850 for “space needed”, the current indication is for zero megabytes (thus indicating that no music has been selected to be synchronized).

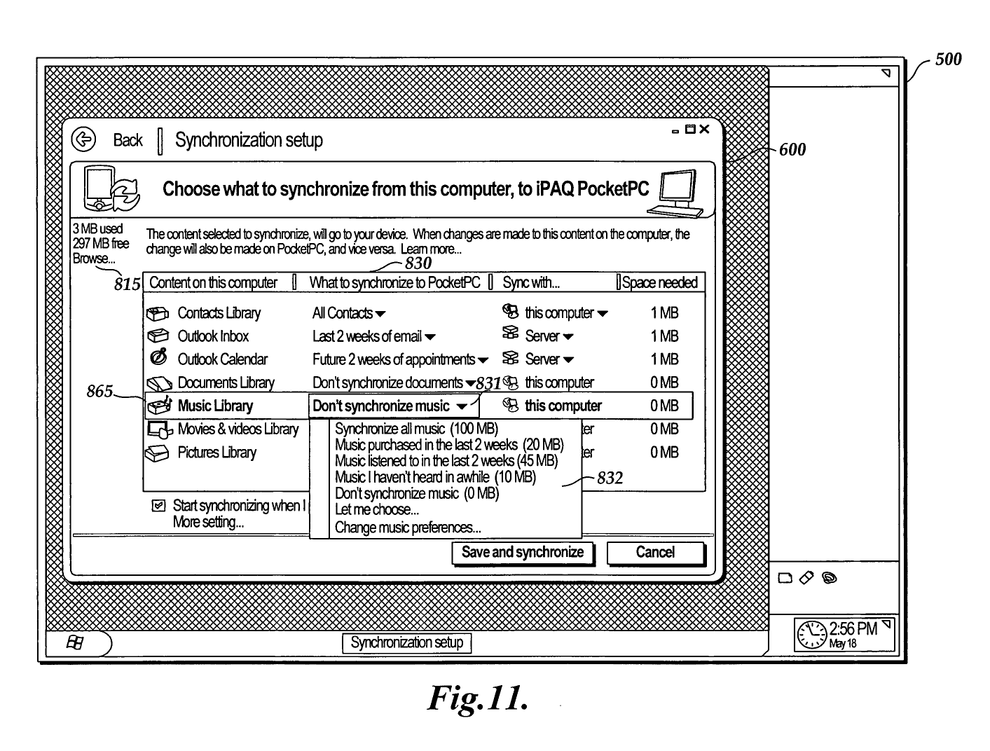

FIG. 11 is a diagram illustrative of a screen display in which the user is provided with options for what specific content to synchronize from the “music library”. As shown in FIG. 11, the user has selected a display area 831 from the display column 830 for determining “what to synchronize to Pocket PC”. Once the display area 831 is selected, a drop-down menu 832 is provided which shows the various selection options and the memory required for each option. For example, the options that are provided in the drop-down window 832 include “synchronize all music (100 MB)”, “music purchased in the last two weeks (20 MB)”, “music listened to in the last two weeks (45 MB)”, “music I haven't heard in awhile (10 MB)”, “don't synchronize music (0 MB)”, “let me choose . . . ”, and “change music preferences . . . ”.

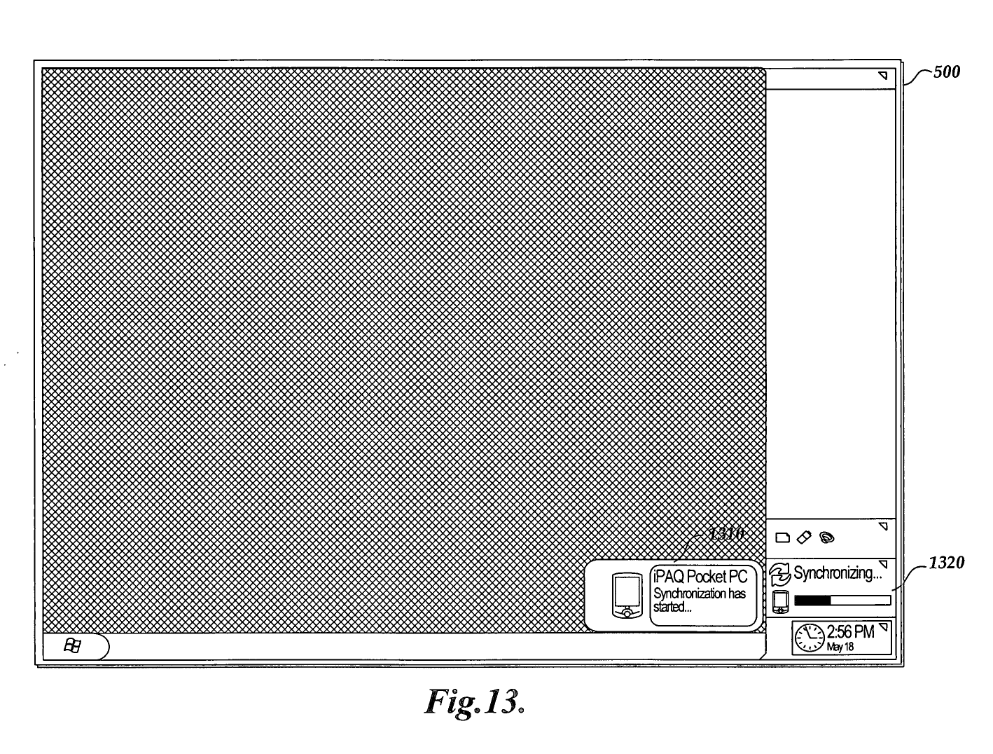

FIG. 12 is a diagram illustrative of a screen display in which the user has changed a selection for the “music library” and in which the user selects “save and synchronize”. More specifically, in the display column 830 for “what to synchronize to Pocket PC”, as shown in a display area 833, the user has changed the selection to be “music purchased in the last two weeks”. As shown in the display column 850 for “space needed”, the selection is now shown to require “20 MB”. As shown in the display area 815, the indication is now “23 MB used, 277 MB free”. The user is also shown to select the button 880 for “save and synchronize”, which continues the process as described in more detail below with reference to FIG. 13.

FIG. 13 is a diagram illustrative of a screen display in which the synchronization process has started and is progressing. As shown in FIG. 13, in a display area 1310 an indication is provided to the user that “iPAQ Pocket PC synchronization has started”. In a display area 1320, the amount of progress is indicated on a progression bar.

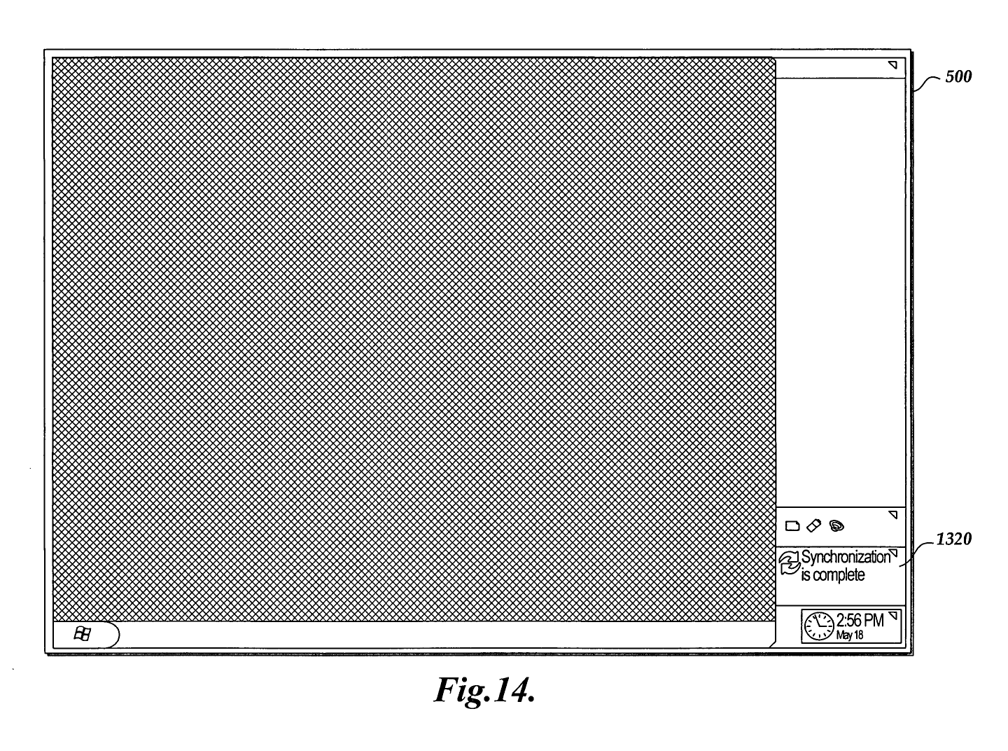

FIG. 14 is a diagram illustrative of a screen display in which the synchronization process has been completed. As shown in FIG. 14, in a display area 1320 the progression bar is no longer provided, and an indication is provided that the “synchronization is complete”. At this point, the iPAQ Pocket PC has been synchronized in accordance with the user's preferences as indicated in FIGS. 6-12, and the iPAQ Pocket PC device may now be disconnected from the computer.

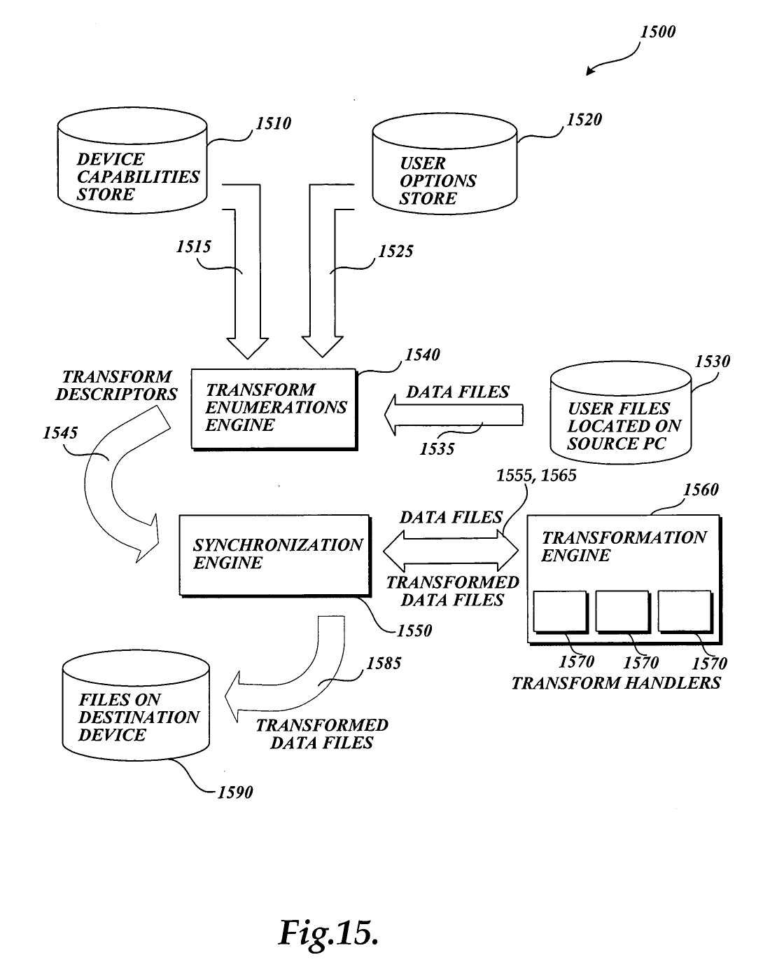

FIG. 15 is a diagram of a synchronization system 1500 in which content may be transformed as part of a synchronization process. As will be described in more detail below, device synchronization via a device's operating system allows users to use the device to roam with their data. Devices possess a wide range of characteristics (e.g., storage size available compared to the storage on the PC, ability to consume the data on the device itself, ability to modify the data using the device, etc.). In accordance with the embodiment of the present invention, content from a PC may be transformed so that the user's experience on the destination device (e.g., mobile phone, portable audio player, PDA, etc.) is optimized. With the transformation being performed as part of the device synchronization process, data from the PC can be optimized for the device. The embodiment of the present invention includes an extensible framework that allows for transformations from specific types of content to be plugged in, or for specific transformations for specific content to be plugged in. Information can be utilized about the device's capabilities that are supplied by the device, by the user, or a combination to determine what transformations should be applied for a data-type as part of the synchronization process.

As shown in FIG. 15, a device capabilities store 1510 and a user options store 1520 provide data 1515 and 1525 to a transform enumeration engine 1540. The transform enumerations engine 1540 receives data files 1535 from a store of user files located on the source PC 1530. The transform enumerations engine 1540 provides transform descriptors 1545 to a synchronization engine 1550. The synchronization engine 1550 exchanges data files 1555 and transformed data files 1565 with a transformation engine 1560. The transformation engine 1560 includes transform handlers 1570. The synchronization engine 1550 provides transformed data files 1585 to a store of files on the destination device 1590.

The device capabilities store 1510 maintains information about a device's capabilities (e.g., codec used, display size/resolution, and space available). The capabilities can be aggregated from a number of sources, from the device itself, from a Web service that provides information about the device, or from the user. The user options store 1520 maintains information about user options for the device synchronization process. This includes options related to transforming data as part of the device synchronization process (e.g., the option to exclude contacts that lack phone numbers as part of the synchronization process for a mobile phone). User options can be stored on a per device and data type basis, on a per data type basis, on a per device basis, or on a to be applied across all device/content types basis.

The transform enumeration engine 1540 enumerates the set of transforms device capabilities, user options, and the nature of the data itself. For example, if a 1024×768 image is on the PC, and the device display supports a resolution of 102×76, the device enumeration engine would identify the need to transform the image from 1024×768 to 102×76. In some cases, there may not be enough information available to identify a transform. In the event that a user option exists then that option overrides any identified default transform.

The synchronization engine 1550 is responsible for managing the transfer of files between the PC and the device. In the case where a transform exists for the device/data-type combination, then the synchronization engine hands off the file along with the transform descriptor to the transformation engine. The transformation engine 1560 abstracts away the multitude of data transformation handlers to the synchronization engine, and is responsible for determining what data transformation handler to call. Once the transformation is complete, the transformation engine passes the newly transformed data to the synchronization engine where it is transferred over to the device. The data transformation handlers 1570 exist on a per data-type basis, e.g., images, video, maps, word documents, contacts, and are used to execute the transform descriptors passed to the transformation engine for the particular data-type. Additional data transformation handlers can be developed for new data-types, can plug-into the transformation engine, and can be used to transform the specified data-type as part of the synchronization process.

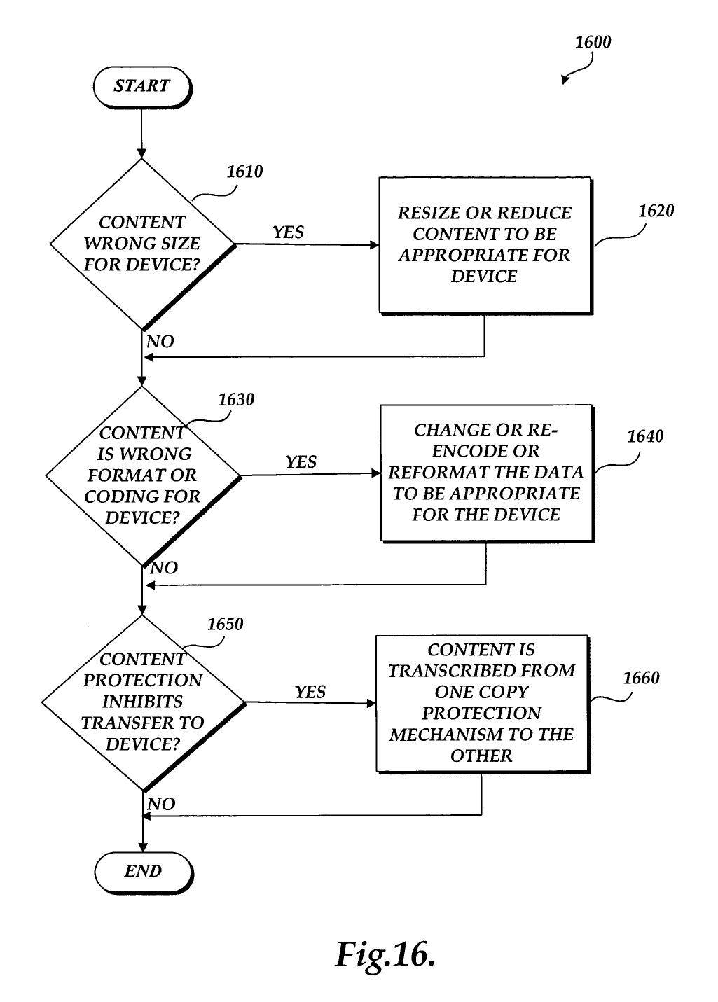

FIG. 16 is a flow diagram illustrative of a general routine 1600 for transforming multiple content types as part of device synchronization. At a decision block 1610, a determination is made as to whether the content is the wrong size for the device. If the content is the wrong size, then the routine continues to a block 1620, where the content is resized or reduced to be appropriate for the device. If the content is not the wrong size for the device, then the routine continues to a decision block 1630.

At decision block 1630, a determination is made as to whether the content is in the wrong format or coding for the device. If the content is in the wrong format or coding, then the routine continues to a block 1640, where the content is reformatted or changed or re-encoded so as to be appropriate for the device. If the content is not in the wrong format or coding for the device, then the routine continues to a decision block 1650.

At decision block 1650, a determination is made as to whether the content protection inhibits the transfer to the device. If the content protection does inhibit the transfer, then the routine continues to a block 1660, where the content is transcribed from one copy protection mechanism to the other. If the content protection does not inhibit the transfer, then the routine ends.

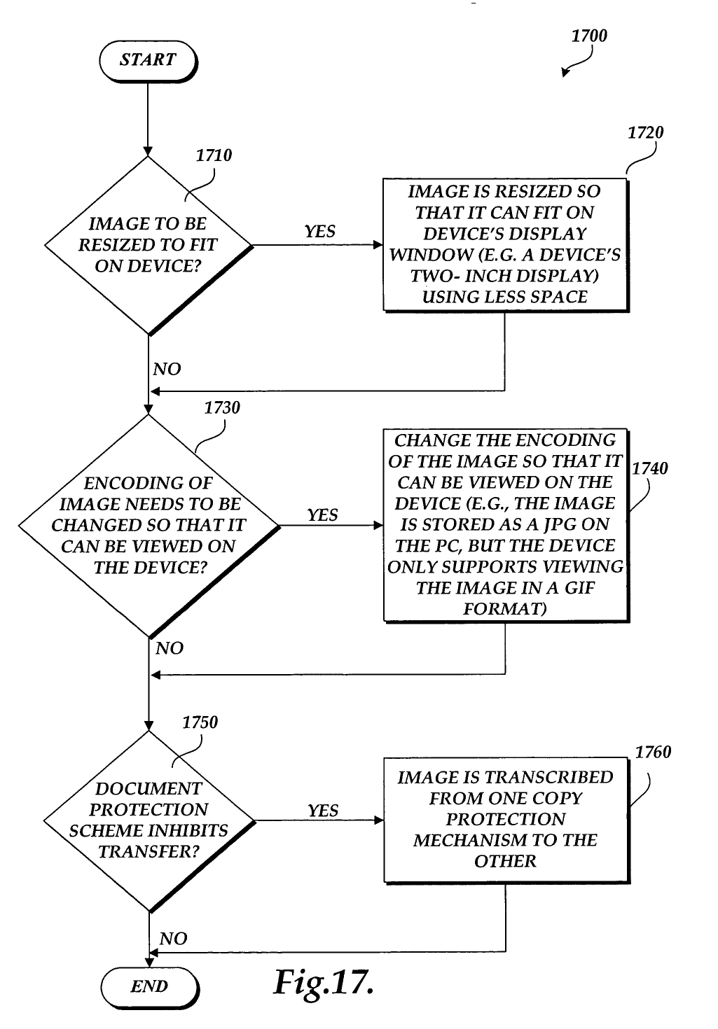

FIGS. 17-21 provide examples of specific transforms organized by data types. It will be understood that these transform examples do not represent an exhaustive list of possible transformations. Since the framework of the embodiment of the present invention is extensible, it will be understood that additional transforms for specific data types or for an entirely new data type can be plugged into the framework.

FIG. 17 is a flow diagram illustrative of a routine 1700 for a transform for image files. At a decision block 1710, a determination is made as to whether the image needs to be resized so that it can fit in the device's display window. If the image does not need to be resized, then the routine continues to a decision block 1730, as will be described in more detail below. If the image does need to be resized, then the routine continues to a block 1720, where the image is resized so that it can fit on a different display window (e.g., a device's 2-inch display) using less space. For example, an image that can fit into a 1024×768 window and consume 1 MB of space may be resized to fit into a 100×100 window on a device while consuming only 100 KB.

At decision block 1730, a determination is made as to whether the encoding of the image needs to be changed so as to be viewable on the device. If the encoding of the image is not to be changed, then the routine continues to a decision block 1750, as will be described in more detail below. If the encoding of the image is to be changed, then the routine continues to a block 1740, where the encoding of the image is changed so that the image can be viewed on the device. For example, if the image is stored as a JPG on the PC, it may need to be reencoded to be viewable on a device that only supports viewing images in the GIF format.

At decision block 1750, a determination is made as to whether the document protection scheme (e.g., DRM, watermarking, etc.) inhibits the transfer of the image to the device or limits the use of the image on the device in some meaningful way. If the image protection scheme does not inhibit the transfer or limit the use of the image, then the routine ends. If the transfer or use is inhibited, then the routine continues to a block 1760, where as part of the device synchronization process, the image is transcribed from one copy protection mechanism to the other.

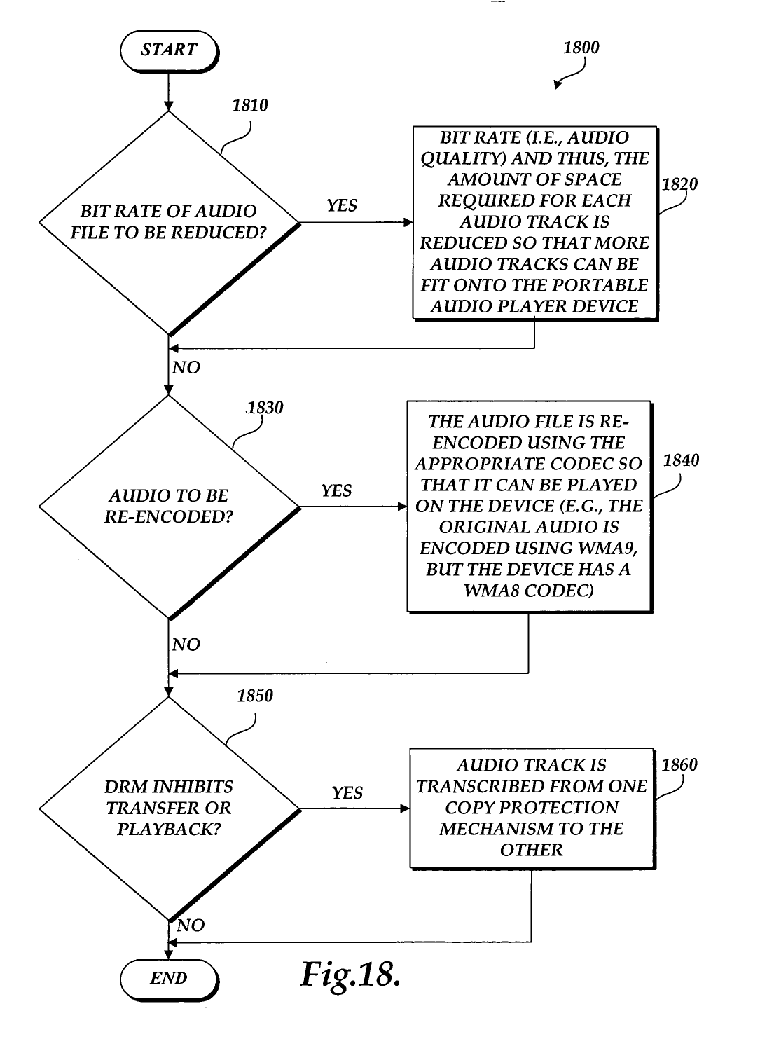

FIG. 18 is a flow diagram illustrative of a routine 1800 for an audio file transform. At a decision block 1810, a determination is made as to whether the bit rate should be reduced. If the bit rate is not to be reduced, then the routine continues to a decision block 1830, as will be described in more detail below. If the bit rate is to be reduced, then the routine continues to a block 1820, where the bit rate (which generally corresponds to audio quality), and thus the amount of space required for each audio track, is reduced so that more audio tracks can be fit onto the portable audio player device.

At decision block 1830, a determination is made as to whether the audio needs to be re-encoded. If the audio does not need to be re-encoded, then the routine continues to a decision block 1850, as will be described in more detail below. If the audio does need to be re-encoded, then the routine continues to a block 1840 where the audio is re-encoded so it can be played back on the device. For example, if the audio is encoded using WMA9, it may need to be reencoded for a device that has the WMA8 codec. Another example would be transcoding between different encoding technologies, such as WMA to MP3.

At decision block 1850, a determination is made as to whether the document protection mechanism (DRM) used on the device and/or the PC does not allow for the audio track to be transferred over and/or played back on the device. If the DRM does not inhibit the process, then the routine ends. If the DRM does inhibit the process, then the routine continues to a block 1860, where as part of the device synchronization process, the audio track is transcribed from one copy protection mechanism to the other.

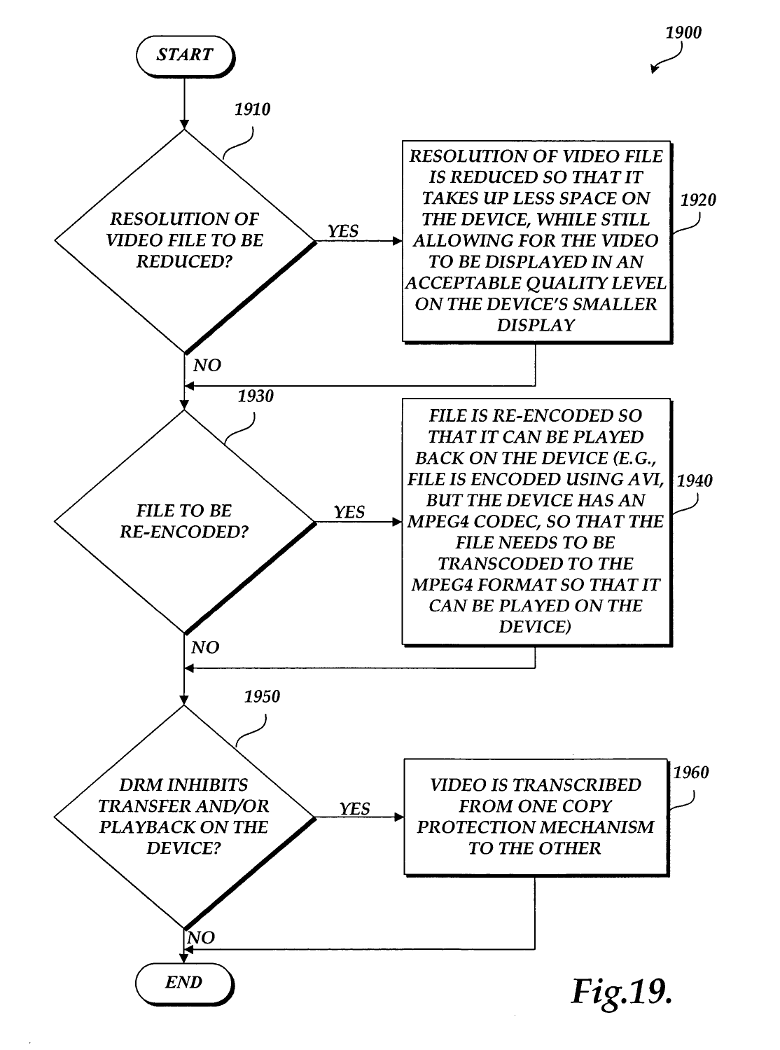

FIG. 19 is a flow diagram illustrative of a routine 1900 for a video file transform. At a decision block 1910, a determination is made as to whether the resolution of the video file needs to be reduced. If the resolution of the video file does not need to be reduced, then the routine continues to a decision block 1930, as will be described in more detail below. If the resolution of the video file does need to be reduced, then the routine continues to a block 1920, where the resolution of the video file is reduced so that it takes up less space on the device, while still allowing for the video to be displayed at an acceptable quality level on the device's smaller display.

At a decision block 1930, a determination is made as to whether the file needs to be re-encoded so that it can be played back on the device. If the file does not need to be re-encoded, then the routine continues to a decision block 1950, as will be described in more detail below. If the audio does need to be re-encoded, then the routine continues to a block 1940, where the file is re-encoded so that it can be played back on the device. For example, if the file is encoded using AVI, but the device has the MPEG4 codec, then as part of the synchronization process the file is transcoded to the MPEG4 format so that it can be played on the device.

At decision block 1950, a determination is made as to whether the document protection mechanism (DRM) used on the device and/or the PC does not allow for the video to be transferred over and/or played back on the device. If the DRM is not inhibiting, then the routine ends. If the DRM is inhibiting, then the routine continues to a block 1960, where as part of the device synchronization process, the video is transcribed from one copy protection mechanism to the other.

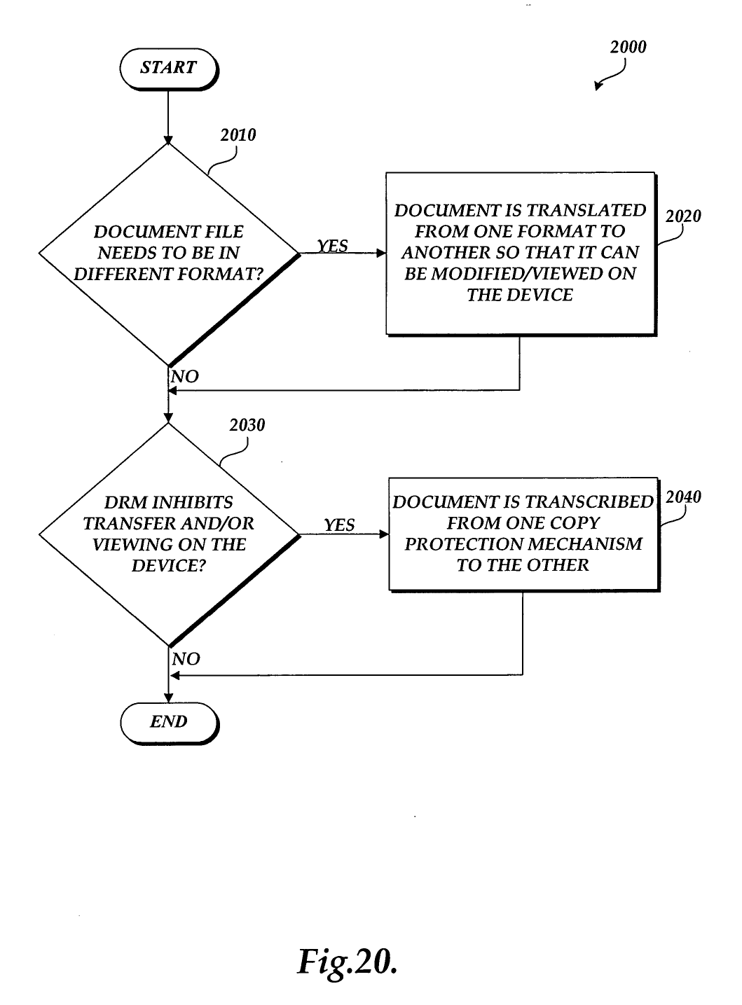

FIG. 20 is a flow diagram illustrative of a routine 2000 for a document file transform. At a decision block 2010, a determination is made as to whether the software used to modify and/or view a document on the device is different than the one used on the PC, and therefore, requires the files to be in a different format. For example, the documents on the PC could be in a Microsoft Office format, but the device requires the files to be in a different format (e.g., HTML, PDF, etc.). If a different format is not required, then the routine continues to a decision block 2030, as will be described in more detail below. If a different format is required, then the routine continues to a block 2020, where as part of the device synchronization process, the document is translated from one format to another so that it can be modified/viewed on the device.

At decision block 2030, a determination is made as to whether the document protection mechanism (DRM) used on the device and/or the PC does not allow for the document to be transferred over and/or viewed on the device. If the DRM is not inhibiting, then the routine ends. If the DRM is inhibiting, then the routine continues to a block 2040, where as part of the device synchronization process, the document is transcribed from one copy protection mechanism to the other.

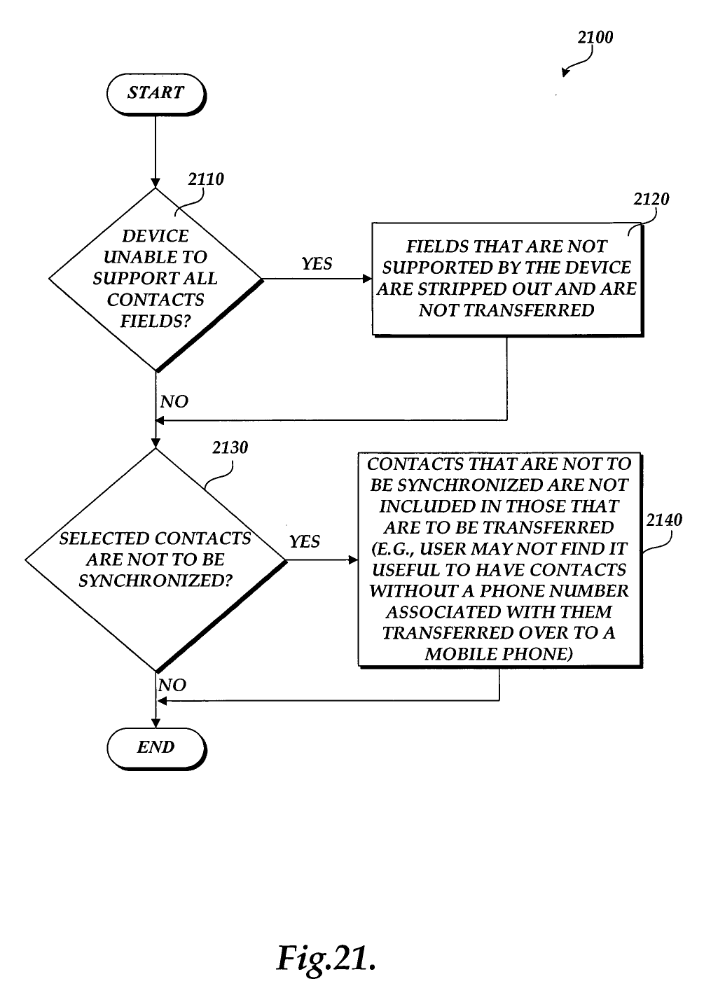

FIG. 21 is a flow diagram illustrative of a routine 2100 for a contacts file transform. At a decision block 2110, a determination is made as to whether the device (e.g., a smart phone) is unable to support all of the fields available on the PC. If the device is able to support all of the fields, then the routine continues to a decision block 2130, as will be described in more detail below. If the device is unable to support all of the fields, then the routine continues to a block 2120, where as part of the device synchronization process, the fields that are not supported by the device are stripped out and are not transferred.

At decision block 2130, a determination is made as to whether there are certain contacts that the user does not want synchronized to the device. For example, certain contacts may be less useful based on the functionality of the device. As a more specific example, a user may not find it useful to have contacts without a phone number associated with them transferred over to a mobile phone. If there are no contacts that are not to be synchronized, then the routine ends. If there are contacts that are not to be synchronized, then the routine continues to a block 2140, where the contacts that are not to be transferred are not included with the transfer data so that they are not transferred to the device.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for synchronization, comprising:
specifying a plurality of content types which are supported and which may be selected for synchronization;
providing a user interface on which one or more of the content types may be selected; and
during a synchronization process synchronizing the selected content types to a device.

2. The method of claim 1, wherein the support for the content types is extensible.

3. The method of claim 1, further comprising specifying a plurality of device classes that are supported for synchronization.

4. The method of claim 3, wherein the support for the device classes is extensible.

5. The method of claim 1, wherein handlers store content selections made by a user.

6. The method of claim 5, wherein a handler is utilized when a synchronization is started.

7. The method of claim 6, wherein the handler is responsible for synchronizing content based on a user's settings.

8. The method of claim 1, wherein a shell provides a synchronization API which can be utilized by the handlers to manage their synchronization relationships.

9. The method of claim 1, wherein as part of a synchronization process a determination is made as to whether the content that is being synchronized needs to be resized for the destination device.

10. The method of claim 1, wherein as part of a synchronization process a determination is made as to whether the content that is being synchronized needs to be reformatted in order to be appropriate for the destination device.

11. The method of claim 1, wherein as part of a synchronization process a determination is made as to whether the content that is being synchronized needs to be re-encoded in order to be appropriate for the destination device.

12. The method of claim 1, wherein applications are able to register for one or more of a plurality of content types, the registrations of the applications allowing the applications to provide UI for configuring the content types.

13. The method of claim 1, wherein a synchronization engine layer is provided at which a handler is invoked when a synchronization is started.

14. A computer-readable medium having computer-executable instructions for performing the steps recited in claim 1.

15. A synchronization system, comprising:
a UI layer, wherein applications are able to register for one or more of a plurality of content types which are supported for synchronization, the registrations allowing the applications to provide UI at the UI layer for configuring the types of content that have been registered for; and
a synchronization engine layer, wherein a handler is invoked when a synchronization is started and the handler is responsible for synchronizing content based on a user's settings.

16. The system of claim 15, further comprising a shell management layer, wherein the handler is responsible for reporting progress of the synchronization back to the shell management layer.

17. The system of claim 16, wherein a synchronization engine API is provided which handlers can use to manage their synchronization relationships.

18. The system of claim 15, wherein the support for the content types is extensible.

19. The system of claim 18, wherein a plurality of device classes are supported for synchronization.

20. The system of claim 19, wherein the support for the device classes is extensible.

21. A computer-readable medium having computer-executable instructions for performing steps comprising:
specifying a plurality of content types that are supported and that can be selected for synchronization;
receiving selection signals indicative of content types that have been selected by a user for synchronization; and
synchronizing the selected content types to an external device.

22. The computer-readable medium of claim 21, wherein the external device falls into one of a plurality of device classes that are supported for synchronization.

23. The computer-readable medium of claim 22, wherein the support for the device classes is extensible.

24. The computer-readable medium of claim 23, wherein the support for the plurality of content types is extensible.

25. The computer-readable medium of claim 21, wherein applications register to handle particular content types, the registering of the applications allowing the applications to provide UI for configuring the content types.

26. The computer-readable medium of claim 21, wherein handlers store selections made by the user and are responsible for synchronizing content based on the user's selections.

27. The computer-readable medium of claim 26, wherein a synchronization engine API is provided which handlers can use to manage their synchronization relationships.

28. A synchronization system, comprising:
a device capabilities store which maintains information about a device's capabilities, such that data that is to be synchronized to the device may be altered to be appropriate for the device; and
a user options store which maintains information about user options for the device synchronization process.

29. The system of claim 28, further comprising a transform enumeration engine which enumerates a set of transforms for device capabilities, user options and the nature of the content that is to be synchronized.

30. The system of claim 29, further comprising a synchronization engine which is responsible for managing the transfer of content between the computer system and an external device.

31. The system of claim 30, further comprising a transform engine which is responsible for determining what handlers to call, and once the transformation is complete passes the newly transformed data to the synchronization engine where it is transferred over to the device.

32. The system of claim 31, wherein the handlers comprise data transformation handlers which correspond to a per data-type basis and are used to execute transform descriptors passed to the transform engine for a particular data-type.

33. A computer-readable medium having computer-executable instructions for performing steps comprising:
determining if content that is to be synchronized to a device needs to be reduced in size in order to be appropriate for the device; and
determining if the content that is to be synchronized needs to be reformatted in order to be appropriate for the device.

34. The computer-readable medium of claim 33, having further computer executable instructions for performing the step of determining if the content protection inhibits the transfer of the content to the device in which case the content will be transcribed from one copy protection mechanism to another.

35. The computer-readable medium of claim 33, wherein the content comprises an image and the size determination is based on whether the image should be reduced to fit on the device's display, and the image is further reviewed to determine if it has the proper encoding for being provided on the device's display.

36. The computer-readable medium of claim 33, wherein the content comprises audio, and the size determination is based on whether the bit rate needs to be reduced, and a determination is made as to whether the content needs to be re-encoded to be appropriate for the device.

37. The computer-readable medium of claim 33, wherein the content comprises video, and the size determination is based on whether the resolution of the video file should be reduced, and a determination is made as to whether the file needs to be re-encoded to be appropriate for the device.

38. The computer-readable medium of claim 33, wherein the content comprises documents, and a determination is made as to whether the documents need to be translated from one format to another so that they can be modified and viewed on the device.

39. The computer-readable medium of claim 33, wherein the content comprises contacts, and a determination is made as to whether the device is unable to support certain fields in the contents in which case those fields are stripped out and are not transferred to the device.

40. The computer-readable medium of claim 33, wherein the framework is extensible in that additional transforms for content data types can be plugged into the framework.
